(19) United States
(12) Patent Application Publication
(10) Pub. No.: US 2013/0264461 A1
(43) Pub. Date: Oct. 10, 2013

(54) RADIATION DETECTING APPARATUS

(71) Applicant: CANON KABUSHIKI KAISHA, Tokyo (JP)

(72) Inventors: Satoshi Okada, Tokyo (JP); Kazumi Nagano, Honjo-shi (JP)

(21) Appl. No.: 13/857,804

(22) Filed: Apr. 5, 2013

(30) Foreign Application Priority Data
Apr. 9, 2012 (JP) 2012-088520

(51) Int. Cl. G01T 1/17

(52) U.S. Cl. CPC G01T 1/17
USPC 250/206

(57) ABSTRACT

A radiation detecting apparatus includes a radiation detector, an electrical circuit configured to perform at least one of transmission and reception of an electrical signal to and from the radiation detector, and a deflection adjusting member configured to adjust a deflection of the radiation detecting apparatus. The radiation detector and the electrical circuit are formed as an integral unit.

### BACKGROUND OF THE INVENTION

1. Field of the Invention

The present invention relates to a radiation detecting apparatus, and particularly to a radiation detecting apparatus used as an X-ray imaging apparatus applicable to medical diagnosis or nondestructive inspection, such apparatus including a photoelectric conversion device. In the present specification, the term “light” includes not only visible light, ultraviolet light, and infrared light but also radiation, such as X-rays and γ-rays.

2. Description of the Related Art

With the advance of digital technology, radiation detecting apparatuses dealing with X-ray images as digital data have been actively developed in recent years. Examples of methods of dealing with X-ray images as digital data include a direct conversion method and an indirect conversion method. In the direct method (or direct conversion method), X-rays are directly converted to an electrical signal and read by a photoelectric conversion element having sensitivity in the wavelength range of X-rays. In the indirect method (or indirect conversion method), X-rays are first converted by a fluorescent member to visible light; and visible light is then converted to an electrical signal and read by a photoelectric conversion element having sensitivity in the wavelength range of visible light.

Image digitization, which allows images to be stored in various media, facilitates image storage, retrieval, and transfer and improves the efficiency of hospital management and operations. Since digitized image information allows computers to perform advanced image processing at high speed, it is expected that better diagnoses can be made.

These days, there has been an accelerated move to achieve improved usability and expanded application of radiation detecting apparatuses by making them lighter and thinner. Japanese Patent Application Laid-Open No. 2010-85260, Japanese Patent Application Laid-Open No. 2005-123446, and International Publication No. WO/2009/054042 each propose a so-called mold-type radiation detecting apparatus in which a sensor module is encased in resin or the like and integrally molded.

A so-called mold-type radiation detecting apparatus having a mold protective layer, such as those proposed in the documents described above, may be lightweight. Also, a radiation detector included in such a radiation detecting apparatus may have waterproof and moisture-proof properties and may be resistant to shock and scratches.

However, the configurations of the related art still have some problems to be solved in order to make the radiation detecting apparatus thinner and more flexible.

When made thinner and more flexible, the radiation detecting apparatus can deform (or bend) to the shape of an object to be measured (hereinafter also referred to as a subject). Such a flexible radiation detecting apparatus (having a certain degree of elasticity and flexibility) can be positioned to fit the shape of an object with an uneven or curved surface. With such a radiation detecting apparatus, radiation can be detected with a high degree of accuracy.

However, if the radiation detecting apparatus is made thinner, the stiffness distribution of a sensor module after molding may dominate the bending properties of the entire radiation detecting apparatus depending on the material, shape, or structure of the sensor module. This means that the radiation detecting apparatus tends to bend particularly in a low-stiffness portion. As a result, if a load (e.g., the subject's body weight) exceeding a predetermined threshold is applied to the radiation detecting apparatus, the stress concentrates in such a low-stiffness portion and causes the radiation detecting apparatus to selectively bend (or warp) significantly.

For example, a sensor module is formed by electrically connecting components, such as a radiation detector and an electrical circuit, via electrical wiring or bump connection. Generally, a connecting portion between components, such as the radiation detector and the electrical circuit, is less resistant to shock. Therefore, if a load exceeding a predetermined threshold is applied to the radiation detecting apparatus, the connecting portion between such components of the sensor module may be damaged by cracking.

That is, if the radiation detecting apparatus is made lighter, smaller, thinner, and more flexible, a stress concentrates in a low-stiffness portion of the radiation detecting apparatus, and thus the shock resistance of the radiation detecting apparatus is degraded. The various embodiments disclosed by the present invention are directed to solving these and other problems that would arise when the radiation detecting apparatus is made thinner and more flexible. Specifically, the embodiments disclosed herein describe a novel radiation detecting apparatus formed by integrally molding a device and a circuit in a resin mold, the radiation detecting apparatus having a flexible structure with enhanced shock resistance.

### SUMMARY OF THE INVENTION

The present invention has been completed as a result of studies by the present inventors. One aspect of the present invention is directed to a radiation detecting apparatus including a radiation detector, an electrical circuit configured to perform at least one of transmission and reception of an electrical signal to and from the radiation detector, and a deflection adjusting member configured to adjust a deflection of the radiation detecting apparatus. The radiation detector and the electrical circuit are formed as an integral unit.

Advantageously, with a novel structure of the radiation detecting apparatus disclosed herein, it is possible to enhance the shock resistance of a thin and small radiation detecting apparatus including a radiation detector and an electrical circuit that are formed as an integral unit.

Also, it is possible to provide a radiation detecting apparatus having a curved detection surface. If the radiation detecting apparatus is configured to uniformly bend when subjected to a load or dropped, the shock resistance and reliability of the radiation detecting apparatus can be improved.

Further features of the present invention will become apparent from the following description of exemplary embodiments with reference to the attached drawings.

### BRIEF DESCRIPTION OF THE DRAWINGS

FIG. 1 is a cross-sectional view illustrating a first embodiment.

FIG. 2 is a cross-sectional view illustrating a second embodiment.

FIG. 3 is a cross-sectional view illustrating a third embodiment.

FIG. 4 is a cross-sectional view illustrating a fourth embodiment.

FIG. 5 is a cross-sectional view illustrating a fifth embodiment.

FIG. 6 is a cross-sectional view illustrating a sixth embodiment.

FIG. 7 is a cross-sectional view illustrating a seventh embodiment.

FIG. 8 is a cross-sectional view illustrating an eighth embodiment.

FIG. 9 is a cross-sectional view illustrating a ninth embodiment.

FIG. 10 is a cross-sectional view illustrating a tenth embodiment.

FIG. 11 is a cross-sectional view illustrating an eleventh embodiment.

FIG. 12A to FIG. 12C are each a cross-sectional view illustrating a twelfth embodiment.

### DESCRIPTION OF THE EMBODIMENTS

A radiation detecting apparatus of the present invention is one that is thin, lightweight, and small and has a certain degree of flexibility. In the present invention, having “a certain degree of flexibility” means being capable of deforming (typically bending) to a certain degree in accordance with the shape of an object to be measured or load applied from the object.

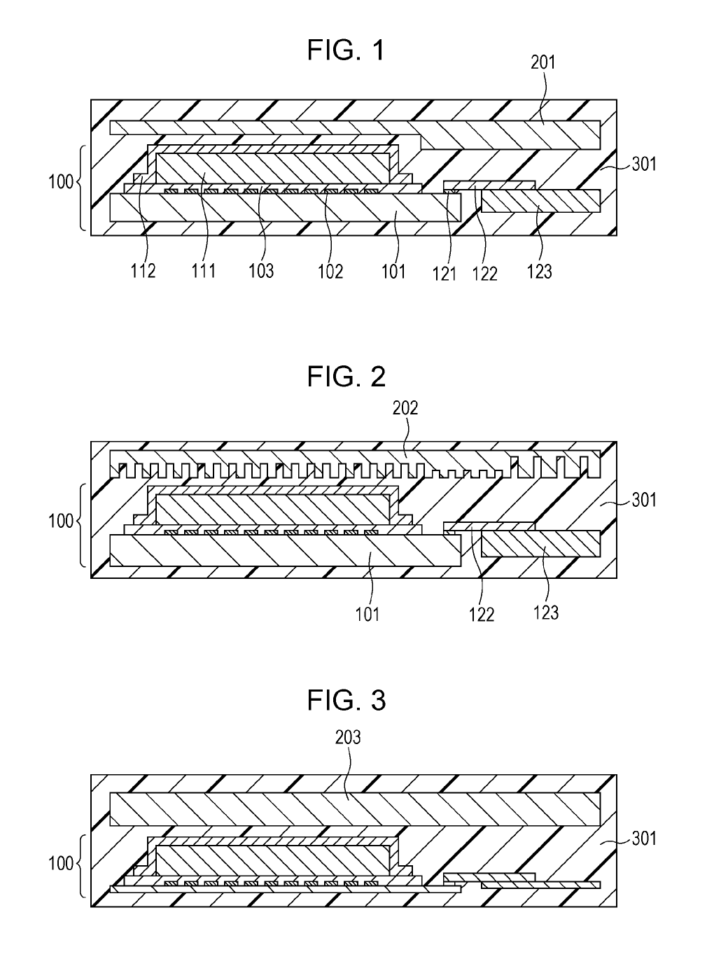

FIG. 1 is a cross-sectional view illustrating a radiation detecting apparatus according to the present invention. Reference numeral 101 denotes a substrate (also referred to as a sensor substrate), reference numeral 102 denotes a photoelectric conversion element serving as a sensor element, and reference numeral 103 denotes a sensor protective layer for protecting the sensor element. Reference numeral 111 denotes a wavelength converter (wavelength conversion element) for converting radiation to visible light (e.g., a wavelength converter using a fluorescent material that emits light when exposed to radiation). Reference numeral 112 denotes a wavelength-converter protective layer for protecting the wavelength converter 111.

The wavelength-converter protective layer 112 may include a reflective layer that reflects light emitted from the wavelength converter 111. Examples of the material that can be used to form the wavelength converter 111 include fluorescent materials, such as GOS (Gd₂O₂S) and CsI. Other examples include NaI (Tl), CsI (Na), CaF₂ (Eu), BaF₂, CeF₃, BGO (Bi₄Ge₃O₁₂), and CdWO₄.

The photoelectric conversion element (sensor element) 102 has the function of converting light emitted by the wavelength converter 111 to an electrical signal. The photoelectric conversion element 102 may be a sensor element having a metal-insulator-semiconductor (MIS) structure or positive-intrinsic-negative (PIN) structure. The photoelectric conversion element 102 may have any configuration that can detect light from the wavelength converter 111.

Reference numeral 123 denotes an electrical circuit member which refers, in the present invention, to a component that transmits a signal to a sensor or processes a signal received from the sensor. Reference numeral 122 denotes an electrical member for transmitting and receiving an electrical signal between the electrical circuit member 123 and the substrate (sensor substrate) 101. Reference numeral 121 is a conductive connecting member formed, for example, by an anisotropic conductive film (ACF) for connecting the electrical member 122 to the sensor substrate 101.

In the present invention, the term “electrical member” refers to an electrical-signal transmitting member used in tape automated bonding (TAB). In the present invention, the term “electrical signal” refers to an electrical signal used in the radiation detecting apparatus, such as a signal supplied from a power supply for driving the sensor or a signal detected by the sensor.

In the present invention, a unit that includes at least a radiation detector and an electrical circuit is referred to as a sensor module, which is denoted by reference numeral 100 in the drawings. The electrical circuit is configured to perform at least one of transmission and reception of an electrical signal to and from the radiation detector. The radiation detector is not limited to one having the wavelength converter 111 described above. For example, the radiation detector may be formed using a material that directly converts radiation to an electrical signal.

Reference numeral 301 denotes a mold member for embedding the entire sensor module 100 therein. Although a resin material is typically used to form the mold member 301, a glass material may be used instead. FIG. 1 illustrates a configuration of the present invention in which the entire sensor module 100 is embedded in the mold member 301. In the present invention, however, the sensor module 100 does not necessarily need to be entirely embedded in the mold member 301. In the basic configuration (excluding a deflection adjusting member) of the present invention, a radiation detector and an electrical circuit are formed as an integral unit, and it is only necessary that at least a connecting portion between the radiation detector and the electrical circuit be embedded in, covered with, or secured by resin or glass material. The radiation detector and the electrical circuit may be integrally covered with a resin or glass cover having a certain degree of elasticity and flexibility.

Examples of the material that can be used to form the mold member 301 in the present invention include thermoplastics, such as polyethylene (PE), polypropylene (PP), polyvinyl chloride (PVC), polystyrene (PS), polycarbonate (PC), acrylonitrile butadiene styrene (ABS), and polyamide (nylon) (PA).

Thermoplastic elastomer (TPE) resin may also be used as the material of the mold member 301. TPE resin is as soft as rubber and as workable as plastic. Because of its easy recyclability, TPE resin has less negative impact on the environment and is used in various products. Examples of the TPE resin include thermoplastic polyester elastomer (TPEE) resin, thermoplastic polyurethane elastomer (TPU) resin, thermoplastic olefin elastomer (TPO) resin, thermoplastic styrene elastomer (TPS) resin, thermoplastic polyamide elastomer (TPEA) resin, and thermoplastic polyvinyl chloride elastomer (TPVC) resin. A mixture of any of these TPE resins and thermoplastic may also be used.

To protect the radiation detector placed in a mold for mold forming from the effect of heat, mold forming may be performed, for example, at a heating temperature of 180° C. or less, preferably 150° C. or less. Therefore, a material that can be used in mold forming, for example, at a heating temperature of 180° C. or less, preferably 150° C. or less, may be appropriately selected from the plastics described above. Alternatively, a conductive resin obtained by dispersing fine metal powder in any of the plastics described above may be used.

An ultraviolet curable resin or photo-curable resin (e.g., photo-curable epoxy resin) may be used as a material of the mold member 301. Using the ultraviolet curable resin or photo-curable resin is advantageous in that since mold forming can be performed near room temperature, there is no need to consider the effect of heat on the radiation detector. To realize a lightweight and thin radiation detecting apparatus, the mold member 301 may be, for example, 10 μm to 10 mm thick.

In the present invention, the mold member 301 can be formed by so-called in-mold forming. For example, after a radiation detector having a grid, a sensor module, and a lead sheet is placed in a mold for mold forming, the material (resin material) of the mold member 301 is ejected into the mold for mold forming. The mold member 301 is thus formed to cover the entire radiation detector.

In the present invention, the mold member 301 may be integrally molded by laminating the sensor module 100 with a sheet member of resin material.

The mold member 301 may be molded, for example, by so-called “vacuum lamination”. Specifically, first, the sensor module 100 is covered with a sheet-like molded filler of resin material, such as ethylene-vinyl acetate (EVA), or is vertically sandwiched between such fillers, to form a laminated body. Then, after vacuum degassing, the EVA filler is melted at a temperature as high as about 150° C. and thermally crosslinked for about 30 minutes to 1 hour. Examples of the resin material that can be used in the present invention include thermoplastic resins, such as ethylene-vinyl acetate copolymer (EVA) resin, ethylene-methyl acrylate copolymer (EMA) resin, ethylene-ethyl acrylate copolymer (EEA) resin, ethylene-acrylic acid copolymer (EAA) resin, ethylene-methacrylic acid copolymer (EMAA) resin, ionomer resin, and polyvinyl butyral resin. Other such materials that can be used include ethylene-unsaturated fatty acid ester-unsaturated fatty acid terpolymer. Of the materials described above, EAA resin, EMAA resin, and ionomer resin (particularly EMAA resin) exhibit good properties in terms of adhesiveness and resistance to weather, heat, cold, and shock, without performing crosslinking with organic peroxide. Therefore, these resin materials can be used in the present invention.

Reference numeral 201 denotes a deflection adjusting member according to the present invention. A deflection adjusting member according to the present invention is for adjusting deflection characteristics (or stiffness distribution) of the entire apparatus that includes a radiation detector and an electrical circuit formed as an integral unit (typically by molding). The deflection adjusting member may also serve as a supporting body or substrate of the apparatus. The deflection adjusting member is designed to correct the deflection distribution resulting from the absence of the deflection adjusting member, and thus to achieve desired deflection characteristics of the entire apparatus. In the present invention, the term “desired deflection” means that the radiation detecting apparatus bends, for example, uniformly, in one direction, in a spherical shape as a whole, or in a specific portion, depending on its application or intended use. The term “desired deflection” may also mean that the radiation detecting apparatus bends to be prevented from being damaged when dropped or when subjected to a load from an object to be measured (e.g., the subject's body weight).

Since the deflection adjusting member is under the influence of heat during mold forming, a material that has some heat resistance and facilitates mechanical design may be used as a material of the deflection adjusting member. Examples of the material include organic resins, such as polyimide (e.g., Kapton (registered trademark) by E. I. du Pont de Nemours and Company), polyphenylene sulfide (PPS), polyarylate (PAR), polysulfone (PSF), polyether sulfone (PES), polyetherimide (PEI), polyamide-imide (PAI), polyether ether ketone (PEEK) phenol resin, polytetrafluoroethylene, polychlorotrifluoroethylene, and silicone resin that are highly heat resistant and are less dependent on the mold forming temperature. Polyethylene terephthalate (PET), polyethylene naphthalate (PEN), and polycarbonate may also be used. Metal that facilitates elastic design may be used as an inorganic material. Aluminum, iron, and an alloy of aluminum and iron may also be used. A laminated sheet of organic resin and metal may also be used. In addition, the deflection adjusting member may be formed of shape memory alloys (SMAs) either alone or mixed with the above-described resins. SMAs are metals that “remember” their original shapes, and thus are useful for forming mechanical structures that—in response to an applied force—change shape, stiffness, position or the like, and are required to return to its original shape, stiffness, position or the like, when the force is not applied. Nickel-Titanium (NiTi) alloys have been found to be particularly useful SMAs, but others are available. Accordingly, SMAs may be particularly advantageous for forming the deflection adjusting member due to the SMAs ability to repeatedly flex or bend without breaking.

The radiation detecting apparatus may include more than one deflection adjusting member as necessary. The deflection adjusting member may be disposed only on the upper side, only on the lower side, or on both the upper and lower sides of the sensor module 100. As necessary, the deflection adjusting member may be disposed on a side face of the sensor module 100. As used herein, the spatially relative terms, such as “upper side”, “lower side”, and the like are used to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below.

The shape of the deflection adjusting member is not particularly limited. The deflection adjusting member may have a planar shape, a rod-like shape, a rib-like shape, or a complex shape with a curved surface.

By varying the thickness of the deflection adjusting member, it is possible to adjust a partial stiffness and the way of bending. The thickness of the deflection adjusting member may be varied by forming protrusions and indentations in the deflection adjusting member. By forming slits in part of the deflection adjusting member and varying their depth, pitch, and shape, it is possible to adjust or design the stiffness or the way of bending of the deflection adjusting member and the entire apparatus. The stiffness of the deflection adjusting member may be adjusted by forming, as necessary, a predetermined number of openings (e.g., circular or polygonal openings) having a predetermined size and shape in predetermined portions of the deflection adjusting member.

The stiffness of the deflection adjusting member may also be adjusted by changing its internal structure. In this case, by embedding fibers or a mesh in part of the deflection adjusting member, it is possible to partially change the density or material of the deflection adjusting member and adjust the partial stiffness. The stiffness of the deflection adjusting member may also be adjusted by internally creating a cavity in part of the deflection adjusting member to partially change the internal structure of the deflection adjusting member.

If the stiffness of the sensor module 100 is lower than that of the deflection adjusting member (i.e., if the stiffness of the deflection adjusting member is dominant), the shape of deflection may be adjusted mainly by adjusting the stiffness distribution of only the deflection adjusting member.

The stiffness and the way of bending may be adjusted or designed by combining a plurality of deflection adjusting members. This can be achieved by stacking a plurality of deflection adjusting members in a portion to be made stiffer. The amount of deflection may be adjusted by stacking a plurality of deflection adjusting members designed to have the same size and, as necessary, by sliding (or displacing) them relative to each other.

For example, the stiffness distribution of a structure molded without using a deflection adjusting member (e.g., a radiation detecting apparatus including a radiation detector and an electrical circuit that are covered with a resin layer to be formed as an integral unit) is determined in advance by an experiment or simulation. Then, the stiffness distribution of the deflection adjusting member is calculated to adjust the stiffness distribution of the entire apparatus to a designed value. The stiffness distribution of the entire apparatus may be designed in accordance with the stiffness distribution of the deflection adjusting member.

The expression “to adjust the stiffness distribution of the entire apparatus to a designed value” means not only to design the stiffness distribution of the entire apparatus to be substantially uniform such that the entire apparatus bends substantially uniformly (i.e., there is no specific region that bends earlier than the other region within an assumed load range), but also to design the stiffness distribution of the entire apparatus to be non-uniform. For example, if the resistance to deflection varies depending on the component of the radiation detecting apparatus (i.e., if the radiation detecting apparatus includes some components susceptible to damage due to their low shock resistance, low mechanical strength, etc.), the region where such a component is located may be designed to be stiffer than the other region. With this configuration, even if a load exceeding the limit of deflection is applied to the radiation detecting apparatus, since a region resistant to load significantly bends first, components susceptible to damage can be protected. In the present invention, “the stiffness distribution is uniform” means that the stiffness distribution is uniform either strictly or substantially. According to the knowledge of the present inventors, the stiffness distribution can be regarded as uniform if its variation is within 10%.

As described above, in accordance with the stiffness distribution of the deflection adjusting member and the strength of components of the radiation detecting apparatus, the stiffness distribution of the entire apparatus may be designed to be uniform, or designed such that a specific region is stiffer (or less stiff).

Even if the stiffness of the deflection adjusting member is lower than that of the mold member 301, the stiffness of the entire apparatus can be adjusted (e.g., the stiffness can be made uniform, or brought close to a designed value having a predetermined distribution (i.e., non-uniformity)) depending on the intended use. In this case, when the deflection adjusting member is designed to be thicker (or stiffer) in a portion having low stiffness without the deflection adjusting member and to be thinner (or less stiff) in a portion having high stiffness without the deflection adjusting member, it is possible to enhance the uniformity of stiffness of the entire apparatus or to adjust the stiffness distribution to a designed value.

In the present invention, by adding a friction cushioning member to an inner part enclosed in the mold member 301, it is possible to reduce friction between different components, reduce interfacial stress caused by bending, and improve reliability.

In the present invention, a friction cushioning member refers to a component having the function of relieving stress (typically bending stress) applied to the radiation detecting apparatus. Specifically, the friction cushioning member is configured to deform or to slide relative to a component in contact with the friction cushioning member to relieve stress.

The friction cushioning member may be a low-friction member configured to allow sliding between components at the contact portion. A low-friction member refers to a component with low surface energy, such as a component formed by application of a fluorine coating.

The friction cushioning member may include a low-elasticity body (also referred to as a low-elasticity member) configured to deform when bending takes place. A low-elasticity member refers to a component having an elastic modulus lower than that of a component in contact therewith. The low-elasticity member may be made of material strong enough to withstand deformation during bending. Specifically, the low-elasticity member may be a foamed member, a gel-like member, a soft member made of silicone resin or the like, a rubber-like member, an adhesive (or adhesive member), or a thermal release sheet (or thermal release layer). A liquid material, such as a silicone oil, may also serve as the low-elasticity member. The friction cushioning member may be provided with a closed or open space. For example, the friction cushioning member may have a porous structure, or may be provided with protrusions and indentations or grooves.

If the friction cushioning member is disposed between the deflection adjusting member and the mold member 301, it is possible to prevent breakage of either the mold member 301 or the deflection adjusting member and improve reliability.

If the friction cushioning member is disposed between deflection adjusting members, it is possible to prevent breakage of the deflection adjusting members and improve reliability. If the friction cushioning member is disposed between the deflection adjusting member and the sensor module 100, it is possible to prevent breakage of either the sensor module 100 or the deflection adjusting member and improve reliability. The friction cushioning member may be in contact with any part of the sensor module 100. For example, the friction cushioning member may be in contact with the wavelength-converter protective layer 112 or the electrical member 122.

If the friction cushioning member is disposed between the sensor module 100 and the mold member 301, it is possible to prevent breakage of either the sensor module 100 or the mold member 301 and improve reliability.

The friction cushioning member may be disposed in part of the contact portion between the sensor module 100 and the mold member 301. In this case, it is necessary to consider the stress distribution and dispose the friction cushioning member in a location where a better effect (i.e., breakage preventing effect) can be expected. The sensor module 100 may include a height adjusting member (also referred to as a level adjusting member).

In the present invention, the height adjusting member may be provided where necessary. The height adjusting member is configured to eliminate level differences in the sensor module 100 to make the sensor module 100 flat, and thus to prevent improper insertion of molding resin between the deflection adjusting member and the sensor module 100.

By direct contact of the height adjusting member and the deflection adjusting member, the improper insertion of molding resin can be reliably prevented. A better effect can be achieved if the height adjusting member is positioned to be flush with the uppermost surface of the sensor module 100. In the present invention, the uppermost surface may be either the front or back side of the sensor module 100. In this case, by bringing the deflection adjusting member into direct contact with both the uppermost surface of the sensor module 100 and the height adjusting member, the improper insertion of molding resin can be reliably prevented.

Although the sensor module 100 is entirely covered with the mold member 301 in the description above, the sensor module 100 may be partially covered with the mold member 301.

In the present invention, when the radiation detecting apparatus bends (i.e., when a certain level of bending stress is applied to the radiation detecting apparatus), a relationship between a neutral plane of bending and the sensor module 100 in the thickness direction of the radiation detecting apparatus is adjusted to further improve the shock resistance. The term “neutral plane of bending” in the present invention will now be described. When a laminated body is bent, the laminated body expands on one side (e.g., front side), contracts on the other side (e.g., back side), and neither expands nor contracts in the middle of the laminated body. A plane inside such a laminated body is referred to as a neutral plane of bending. In the present invention, the sensor module 100 may be designed to be integrally molded with resin material such that the neutral plane of bending is located within a less shock-resistant region in a component of the sensor module 100.

In the present invention, the term “integrally” refers to a state in which the radiation detector and the electrical circuit are integrally molded with resin material (or typically a state in which the radiation detector and the electrical circuit are embedded in resin). In the present invention, however, the radiation detector and the electrical circuit do not necessarily need to be entirely covered with resin material. That is, for example, the radiation detector and the electrical circuit may be entirely covered with or embedded in resin material, or a connecting portion between the radiation detector and the electrical circuit may be partially covered with resin material. The radiation detector and the electrical circuit may be configured such that at least part of them (or typically a connecting portion between them) is covered with a sheet member made of resin material. The radiation detector and the electrical circuit may be integrally formed by being secured either mechanically (e.g., with screws, hooks, or a fitting structure) or chemically (e.g., with an adhesive) to a substrate or supporting body made of resin material, glass, or metal and having a certain degree of elasticity.

According to the knowledge of the present inventors, since bending may cause delamination at the interface between a wavelength converter unit and a sensor unit, the radiation detecting apparatus may be configured such that the neutral plane of bending is located within a region where these units are joined to each other in the thickness direction.

In the present invention, radiation may be incident from either the front side (having the photoelectric conversion element 102 or sensor element formed thereon) or the back side of the sensor substrate 101.

The technical concepts described above may be applied by appropriately combining them.

The present invention will now be described in more detail with reference to embodiments and the drawings, but the present invention is not to be limited to them.

### First Embodiment

FIG. 1 is a cross-sectional view of a radiation detecting apparatus according to a first embodiment. The sensor substrate 101 and the electrical circuit member 123 are connected to each other via the electrical member 122. Therefore, if the electrical member 122 has a certain degree of elasticity, the sensor substrate 101 and the electrical circuit member 123 can bend to some extent.

The thickness of the deflection adjusting member 201 is varied to make the deflection adjusting member 201 thicker in a portion that needs to be stiffer. In the sensor module 100, the stiffness is low in the region of the electrical member 122 and the electrical circuit member 123 and high in the region of the sensor substrate 101. The deflection adjusting member 201 is made thicker above the region of the electrical member 122 and the electrical circuit member 123 where the stiffness is low, and is made thinner above the region of the sensor substrate 101 where the stiffness is high. The thickness of the deflection adjusting member 201 may be varied either stepwise or continuously.

This configuration changes the overall stiffness, so that the radiation detecting apparatus encased in the mold member 301 achieves desired deflection characteristics.

It is thus possible to design a radiation detecting apparatus having deflection characteristics appropriate for the intended use. The radiation detecting apparatus can bend to absorb shock when dropped or subjected to load from a subject. Therefore, the radiation detecting apparatus is less prone to cracks and breakage, and its reliability can be improved.

### Second Embodiment

FIG. 2 is a cross-sectional view of a radiation detecting apparatus according to a second embodiment. A deflection adjusting member 202 is subjected to slit processing. In the present embodiment, the term “slit processing” refers to forming grooves in the deflection adjusting member 202. The depths and pitches of the slits are appropriately designed for the intended use. That is, the deflection adjusting member 202 is made thicker (or slits are made narrower or shallower) in a portion to be made stiffer, and is made thinner (or slits are made wider or deeper) in a portion to be made less stiff.

In the sensor module 100, the electrical circuit member 123 is the stiffest component, the sensor substrate 101 is the next, and the electrical member 122 is the least. Therefore, the slits of the deflection adjusting member 202 above the electrical member 122 having the lowest stiffness are made shallowest, and the slits of the deflection adjusting member 202 above the electrical circuit member 123 having the highest stiffness are made deepest. This configuration changes the overall stiffness, so that the radiation detecting apparatus encased in the mold member 301 achieves desired deflection characteristics.

It is thus possible to design a radiation detecting apparatus having a uniform stiffness or intended stiffness distribution (or deflection characteristics). The radiation detecting apparatus can bend to absorb shock when dropped or subjected to load from a subject. Therefore, the radiation detecting apparatus is less prone to cracks and breakage, and its reliability can be improved.

### Third Embodiment

FIG. 3 is a cross-sectional view of a radiation detecting apparatus according to a third embodiment. The stiffness of a deflection adjusting member 203 is made sufficiently greater than the strengths of the sensor module 100 and the mold member 301, so that the deflection adjusting member 203 dominates the overall deflection characteristics.

With this configuration, desired deflection characteristics can be achieved by designing only the deflection adjusting member 203. Since there is no need to consider the balance with other components, the design flexibility is improved. This configuration changes the overall stiffness, so that the radiation detecting apparatus encased in the mold member 301 achieves intended deflection characteristics (or stiffness distribution).

It is thus possible to design a radiation detecting apparatus having deflection characteristics appropriate for the intended use. Since the radiation detecting apparatus can bend to absorb shock when dropped or subjected to load from a subject, the reliability of the radiation detecting apparatus can be improved.

### Fourth Embodiment

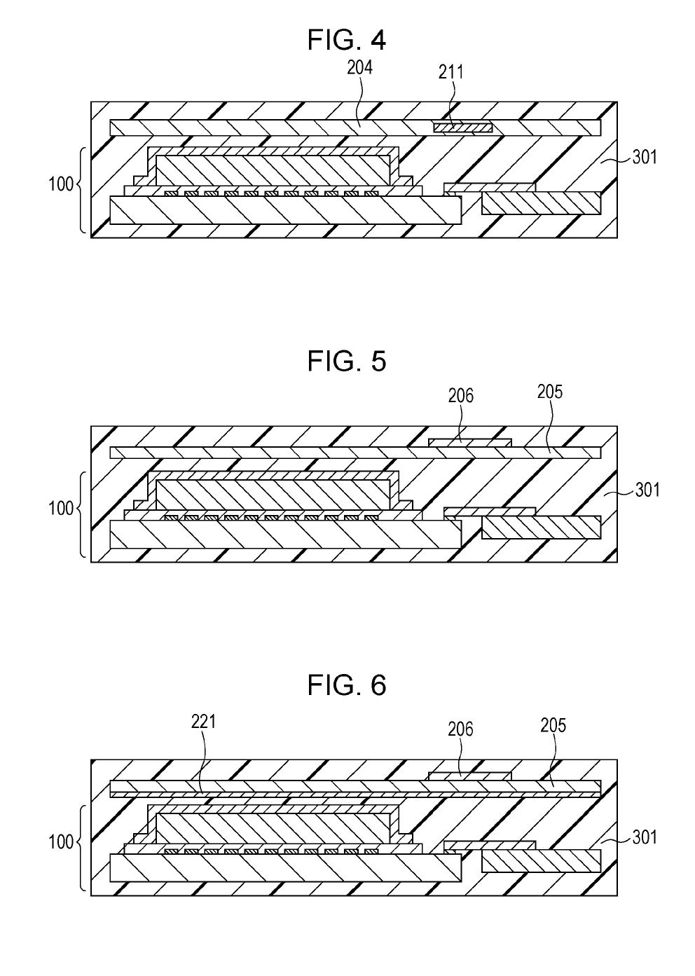

FIG. 4 is a cross-sectional view of a radiation detecting apparatus according to a fourth embodiment. A carbon fiber mesh 211 is embedded in the material of a deflection adjusting member 204 to increase the stiffness of this portion. Instead of the carbon fiber mesh 211, a material having a stiffness different from that of the base material of the deflection adjusting member 204 may be embedded. The material to be embedded and the base material of the deflection adjusting member 204 may be of different types, or may be of the same type but have different stiffnesses because of the difference in structure. An adjustment of the stiffness can be made by creating a cavity in the deflection adjusting member 204 using the same type or a different type of material. This configuration changes the overall stiffness, so that the radiation detecting apparatus encased in the mold member 301 achieves intended deflection characteristics.

It is thus possible to design a radiation detecting apparatus having deflection characteristics appropriate for the intended use. The radiation detecting apparatus can bend to absorb shock when dropped or subjected to load from a subject. Therefore, the radiation detecting apparatus is less prone to cracks and breakage, and its reliability can be improved.

### Fifth Embodiment

FIG. 5 is a cross-sectional view of a radiation detecting apparatus according to a fifth embodiment. As illustrated, the radiation detecting apparatus includes two deflection adjusting members 205 and 206. The two deflection adjusting members 205 and 206 are provided in a portion that needs to be stiffer, whereas only the deflection adjusting member 205 is provided in a portion that does not need to be stiffer.

With this configuration, there is no need to provide a deflection adjusting member having a complex shape. The overall stiffness is changed, and the radiation detecting apparatus encased in the mold member 301 achieves desired deflection characteristics.

It is thus possible to design a radiation detecting apparatus having deflection characteristics appropriate for the intended use. The radiation detecting apparatus can bend to absorb shock when dropped or subjected to load from a subject. Therefore, the radiation detecting apparatus is less prone to cracks and breakage, and its reliability can be improved.

### Sixth Embodiment

FIG. 6 is a cross-sectional view of a radiation detecting apparatus according to a sixth embodiment. As illustrated, a friction cushioning member 221 is added to the deflection adjusting members 205 and 206 of the fifth embodiment. The friction cushioning member 221 is formed by applying a fluorine coating to the deflection adjusting member 205 in advance. Since a contact force between the fluorine coating and the mold member 301 is weakened, sliding takes place between them when the entire apparatus bends. The internal stress caused by the bending can thus be relieved.

Examples of the friction cushioning member 221 include not only the fluorine coating, but also a foamed member, a gel-like member, a soft member made of silicone resin or the like, a rubber-like member, an adhesive (or adhesive member), and a thermal release sheet (or thermal release layer). A liquid material, such as a silicone oil, may also serve as the friction cushioning member 221. Instead of adding the friction cushioning member 221, a space may be created between the deflection adjusting member 205 and a component in contact with the deflection adjusting member 205 to provide cushioning against friction.

With this configuration, it is possible to reduce the occurrence of breakage and distortion resulting from internal stress caused by bending, and thus to improve reliability of the radiation detecting apparatus.

### Seventh Embodiment

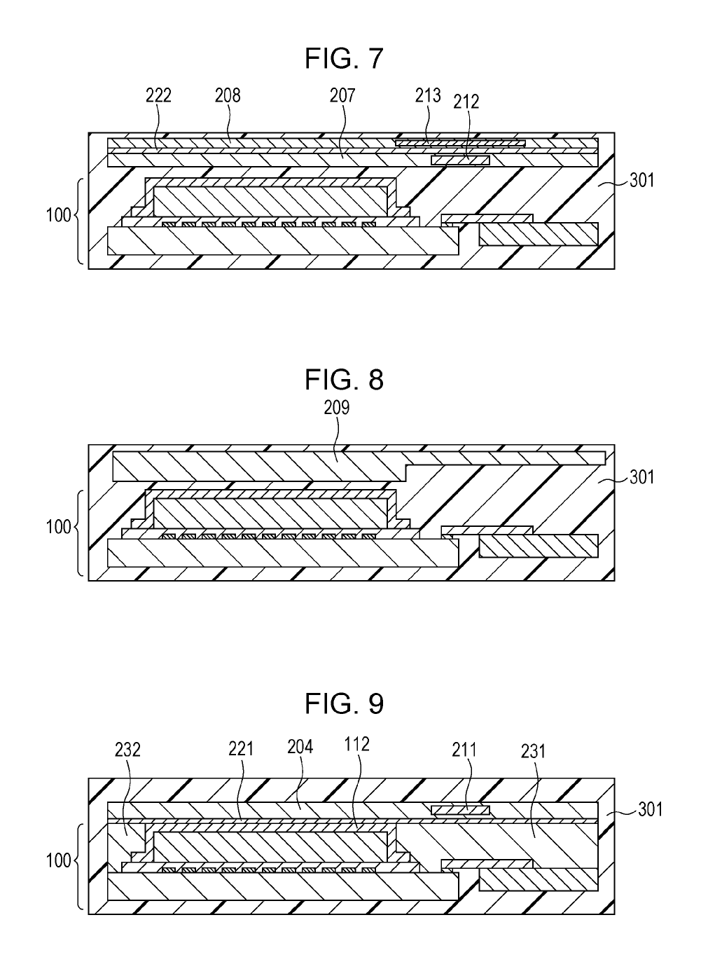

FIG. 7 is a cross-sectional view of a radiation detecting apparatus according to a seventh embodiment. As illustrated, the radiation detecting apparatus includes two deflection adjusting members 207 and 208. The two deflection adjusting members 207 and 208 are configured to slide relative to each other and bend. For adjustment of deflection, carbon fiber meshes 212 and 213 are embedded in the deflection adjusting members 207 and 208, respectively. A friction cushioning member 222 is formed by applying a coating to the deflection adjusting member 207. The friction cushioning member 222 ensures smooth sliding between the deflection adjusting members 207 and 208.

With this configuration, which uses sliding, a deflection caused by displacement of the apparatus can be controlled more smoothly than in the case of using a single deflection adjusting member. This configuration changes the overall stiffness, so that the radiation detecting apparatus encased in the mold member 301 achieves desired deflection characteristics.

It is thus possible to design a radiation detecting apparatus having deflection characteristics appropriate for the intended use. The radiation detecting apparatus can bend to absorb shock when dropped or subjected to load from a subject. Therefore, the radiation detecting apparatus is less prone to cracks and breakage, and its reliability can be improved.

### Eighth Embodiment

FIG. 8 is a cross-sectional view of a radiation detecting apparatus according to an eighth embodiment. In this radiation detecting apparatus, the stiffness of a deflection adjusting member 209 is lower than those of the mold member 301 and the sensor module 100. Unlike the configuration of the first embodiment, the deflection adjusting member 209 is made thinner in a portion which is to be stiffer, and is made thicker in a portion which is to be less stiff.

The deflection adjusting member 209 may be, for example, a hollow member or a low-stiffness member, such as a foamed member. If the deflection adjusting member 209 is made of material having a specific gravity lower than those of the mold member 301 and the sensor module 100, the weight of the entire apparatus can be reduced with this configuration.

This configuration changes the overall stiffness, so that the radiation detecting apparatus encased in the mold member 301 achieves desired deflection characteristics. It is thus possible to design a radiation detecting apparatus having deflection characteristics appropriate for the intended use. The radiation detecting apparatus can bend to absorb shock when dropped or subjected to load from a subject. Therefore, the radiation detecting apparatus is less prone to cracks and breakage, and its reliability can be improved.

### Ninth Embodiment

FIG. 9 is a cross-sectional view of a radiation detecting apparatus according to a ninth embodiment. Height adjusting members 231 and 232 are disposed in an upper part of the sensor module 100 to be flush with the wavelength-converter protective layer 112 in the uppermost part of the sensor module 100. Thus, by making the stepped complex shape flat, the height adjusting members 231 and 232 adjust the height at which the deflection adjusting member 204 is to be placed.

The deflection adjusting member 204 coated with the friction cushioning member 221 is disposed directly over the height adjusting member 231 and the wavelength-converter protective layer 112. This allows sliding to take place between the deflection adjusting member 204 and the height adjusting member 231 and the wavelength-converter protective layer 112. With this configuration, it is possible to prevent improper insertion of the mold member 301 which needs to be inserted between the deflection adjusting member 204 and the sensor module 100.

The height adjusting members 231 and 232 may be formed by placing a material processed into a desired shape in advance in the sensor module 100, or by application of liquid resin. This configuration changes the overall stiffness, so that the radiation detecting apparatus encased in the mold member 301 achieves desired deflection characteristics. It is thus possible to design a radiation detecting apparatus having deflection characteristics appropriate for the intended use. The radiation detecting apparatus can bend to absorb shock when dropped or subjected to load from a subject. Therefore, the radiation detecting apparatus is less prone to cracks and breakage, and its reliability can be improved.

### Tenth Embodiment

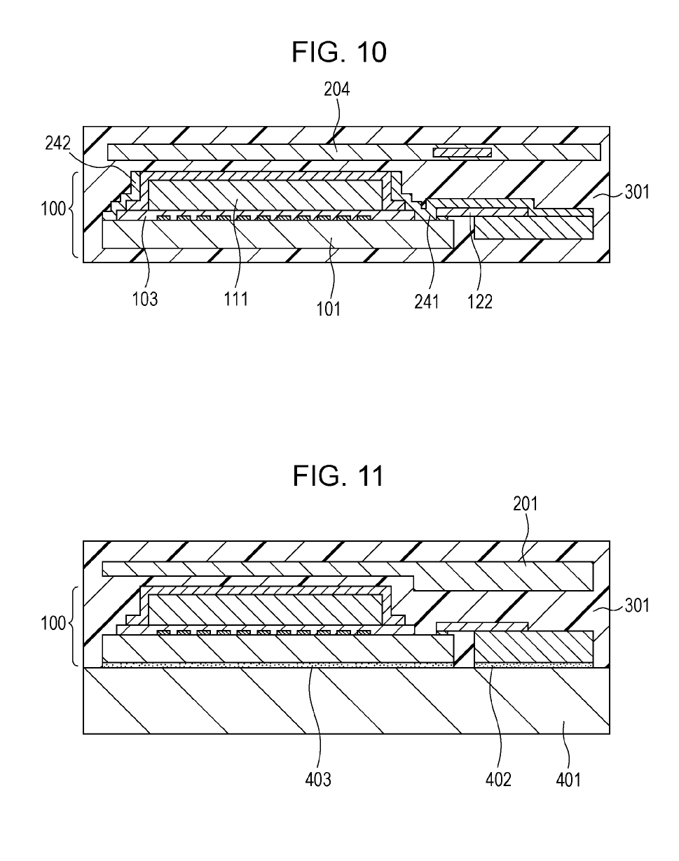

FIG. 10 is a cross-sectional view of a radiation detecting apparatus according to a tenth embodiment. Friction cushioning members 241 and 242 formed by foamed members are disposed in part of the contact between the sensor module 100 and the mold member 301. To prevent breakage, the friction cushioning members 241 and 242 expand and contract to relieve stress between the mold member 301 and the sensor module 100 caused by bending of the entire apparatus. This is particularly effective in reducing the occurrence of separation between the wavelength converter 111 and the sensor protective layer 103 and also between the electrical member 122 and the sensor substrate 101.

### Eleventh Embodiment

FIG. 11 is a cross-sectional view of a radiation detecting apparatus according to an eleventh embodiment. As illustrated, the sensor module 100 is not entirely covered with the mold member 301. Instead, the underside of the sensor module 100 is bonded to a base 401 by adhesive layers 402 and 403 therebetween.

Since the deflection adjusting member 201 is embedded in the mold member 301, this configuration can be regarded as an embodiment of the present invention.

If the mold member 301 is partially replaced by a different material as described above, it is possible to solve difficulties associated with insertion of the mold member 301.

### Twelfth Embodiment

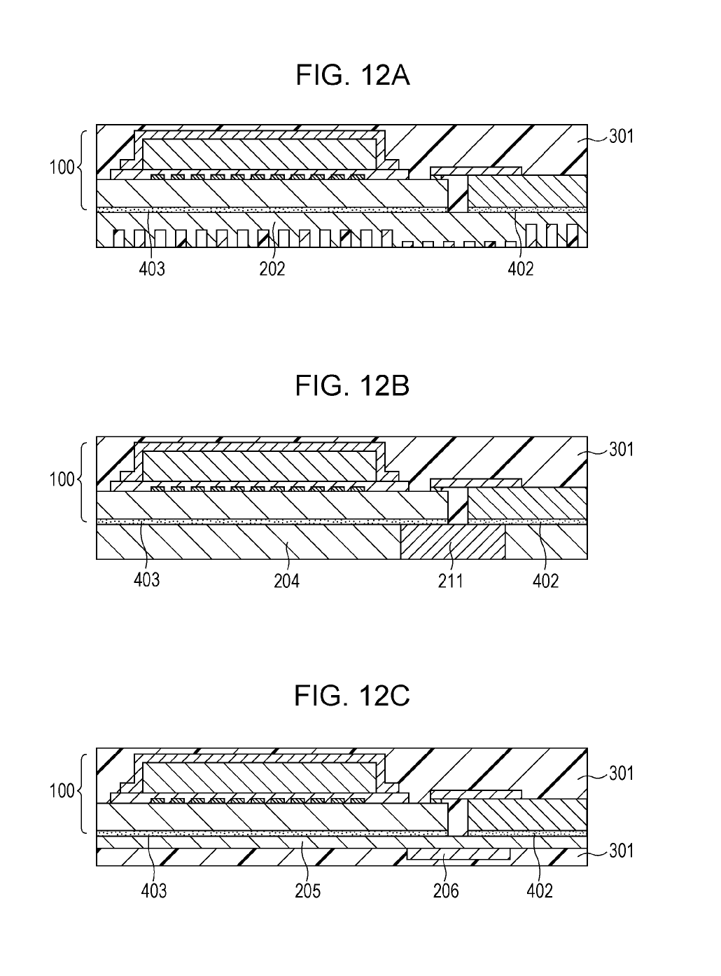

FIG. 12A to FIG. 12C are each a cross-sectional view of a radiation detecting apparatus according to a twelfth embodiment. The deflection adjusting members 202, 204, 205, and 206 are each configured to serve also as a supporting body that supports the sensor module 100 (i.e., a unit including a radiation detector and an electrical circuit).

The deflection adjusting member 202 illustrated in FIG. 12A is provided with slots or openings, in accordance with the stiffness distribution of the sensor module 100, so that the stiffness distribution of the entire apparatus is as uniform as possible. The deflection adjusting member 204 and the dissimilar material embedded portion (or carbon fiber mesh) 211 illustrated in FIG. 12B are formed by combining materials of different stiffnesses together so that the stiffness distribution of the entire apparatus is as uniform as possible. Of the deflection adjusting members 205 and 206 illustrated in FIG. 12C, the deflection adjusting member 206 is placed selectively in a low-stiffness portion of the sensor module 100 so that the stiffness distribution of the entire apparatus is as uniform as possible. Although the radiation detecting apparatus illustrated in FIG. 12C includes the two separate deflection adjusting members 205 and 206, a similar effect can be achieved by adjusting the thickness of a single deflection adjusting member.

Although the stiffness distribution of the entire radiation detecting apparatus is uniform in the twelfth embodiment, the radiation detecting apparatus may be made stiffer (or less stiff) in a specific region, as necessary, and thus may have a non-uniform stiffness distribution.

As described above, since the deflection adjusting members 202, 204, 205, and 206 each serve also as a supporting body that supports the sensor module 100, it is possible to reduce the number of components and simplify the structure. This is also advantageous in terms of cost saving.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-088520 filed Apr. 9, 2012, which is hereby incorporated by reference herein in its entirety.

What is claimed is:

1. A radiation detecting apparatus comprising:
a radiation detector;
an electrical circuit configured to perform at least one of transmission and reception of an electrical signal to and from the radiation detector; and
a deflection adjusting member configured to adjust a deflection of the radiation detecting apparatus,
wherein at least the radiation detector and the electrical circuit are formed as an integral unit.

2. The radiation detecting apparatus according to claim 1, wherein a stiffness of one part of the deflection adjusting member is different from a stiffness of another part of the deflection adjusting member.

3. The radiation detecting apparatus according to claim 1, wherein a thickness of one part of the deflection adjusting member is different from a thickness of another part of the deflection adjusting member.

4. The radiation detecting apparatus according to claim 1, wherein a material of one part of the deflection adjusting member is different from a material of another part of the deflection adjusting member.

5. The radiation detecting apparatus according to claim 1, wherein the deflection adjusting member is provided in plurality member.

6. The radiation detecting apparatus according to claim 1, further comprising a friction cushioning member configured to relieve stress caused by bending of the radiation detecting apparatus.

7. The radiation detecting apparatus according to claim 6, wherein the friction cushioning member has sliding properties.

8. The radiation detecting apparatus according to claim 6, wherein the friction cushioning member includes a low-elasticity body having an elastic modulus lower than that of a component in contact therewith.

9. The radiation detecting apparatus according to claim 8, wherein the low-elasticity body includes at least one of a foamed member, a rubber-like member, an adhesive member, and a gel-like member.

10. The radiation detecting apparatus according to claim 6, wherein the friction cushioning member includes a thermal release layer.

11. The radiation detecting apparatus according to claim 1, further comprising a height adjusting member configured to adjust a height at which the deflection adjusting member is to be placed.

12. The radiation detecting apparatus according to claim 1, wherein the radiation detector and the electrical circuit are entirely covered with a resin material.
